(19) United States
(12) Patent Application Publication
(10) Pub. No.: US 2007/0082217 A1
(43) Pub. Date: Apr. 12, 2007

(54) Wear Resistant Consumable

(75) Inventor: Robert F. Miller, Birmingham, AL (US)

Correspondence Address: TAROLLI, SUNDHELM, COVELL & TUMMINO, LLP, 1300 EAST NINTH STREET, SUITE 1700, CLEVELAND, OH, 44114, US

(73) Assignee: Postle Industries, Inc., Middleburg Heights, OH (US)

(21) Appl. No.: 11/530,772

(22) Filed: Sep. 11, 2006

Related U.S. Application Data
(60) Provisional application No. 60/725,354, filed on Oct. 11, 2005.
(60) Provisional application No. 60/726,391, filed on Oct. 13, 2005.

(51) Int. Cl. B32B 15/04; B32B 15/00

(52) U.S. Cl. 428/627; 428/655

(57) ABSTRACT

Wear protecting an object by providing a metal object having a desired shape for a task and forming containers in said metal object in regions of said object that are subject to wear with use. The containers are filled with a more wear resistant material to prolong the useful life of said object. A preferred wear resistant material is a sound deposit iron based alloy.

### CROSS REFERENCE TO RELATED APPLICATIONS

The present invention claims priority from U.S. provisional applications Ser. Nos. 60/725,354 and 60/726,391 filed Oct. 11^{th} and Oct. 13^{th}, 2005 which are incorporated herein by reference.

### FIELD OF THE INVENTION

The invention relates to a welding method and/or product that uses an arc welding process that creates a consumable that can be attached into place by means of welding brazing or by bolting.

### BACKGROUND ART

It is well know in the prior art to provide wear protection surfaces to parts by arc welding or stud welding methods. In the case of arc welding methods, many highly abrasion resistant consumables, such as the Chromium Carbide and Tungsten Carbide families are limited to total deposit thickness which are generally achieved by depositing 2 to 3 layers. This equates to ½″ to 9/16″ in deposit thickness. Additional layers result in spalling of the weld deposit. Studs welded onto surfaces for wear protection are limited in thickness to about ½″ and therefore limited in wear protection. Adjusting chemistry to compensate for the thickness limitations and better wear resistance results in excessive brittleness and in premature failures.

A distinct advantage to both of these techniques is their ability to be applied out-of-position which many hardfacing consumables are incapable. This is a distinct advantage for field applications. This invention incorporates the out-of-position advantages as well as increasing deposit thicknesses of arc welded parts without excessive brittleness and/or spalling.

Prior art arc welded wear resistant deposits often contain cracks or “check cracks” as they are sometimes referred to. They are a direct result of metallurgical microstructures, welding parameters and cooling rates. Such cracks are tolerated in some applications, and even desired in others.

### SUMMARY OF THE INVENTION

The disclosure concerns a method of protecting a component from wear by providing a metal object having a desired shape for a task and forming containers in said metal object in regions of the component that are subject to wear with use. The containers are filled with a more wear resistant material to prolong the useful life of the component. The exemplary wear resistant material is an iron, nickel or cobalt alloy which produces a sound deposit, i.e. no check cracks of the resulting wear resistant material for filling the containers.

Check cracks are not desired in the embodiment of the invention. Alloys exhibiting sound deposits, having no cracks, slag entrapment, or porosity, are desirable in this application.

These and other advantages and features of the disclosure are better understood by reference to the accompanying drawings.

### BRIEF DESCRIPTION OF THE DRAWINGS

FIG. 1 is a perspective view of a container used in practicing one exemplary embodiment of the invention;

FIG. 2 is a perspective view of the container of FIG. 1 filled with a wear resistant material;

FIG. 3 is view depicting the container fillet welded to a support base or substrate;

FIGS. 4, 4A, and 4B illustrate a supporting bolt for use with the container;

FIG. 5 shows a container having a threaded end for attachment to a correspondingly threaded support;

FIG. 6 illustrates an array of containers attached to a substrate.

FIG. 7 shows a container plate attached to substrate plate.

FIG. 8 is a perspective view of a crushing hammer;

FIG. 9 illustrates a fan blade having containers positioned to improve wear resistance.

FIG. 10, illustrates of a dozer shoe grouser having containers placed for wear resistance.

FIG. 11 is a perspective view of a dozer track pad having containers placed for wear protection

FIG. 12 shows the use of a stackable container(s) for the manufacturing of a wear plate.

FIG. 13 illustrates a method of producing portable containers that are filled, heat treated and quenched to obtain a hard abrasion resistant consumable.

FIG. 14 shows the solution heat treatment station after the container has been filled.

FIG. 15 shows the water quenching or cooling station after the container has been filled and has been solution heat treated.

FIG. 16 shows a jaw crusher liner plate with filled containers of wear resistant material.

FIG. 17. shows a cone crusher mantle with filled containers of wear resistant material in strategic locations of high wear.

### EXEMPLARY EMBODIMENT

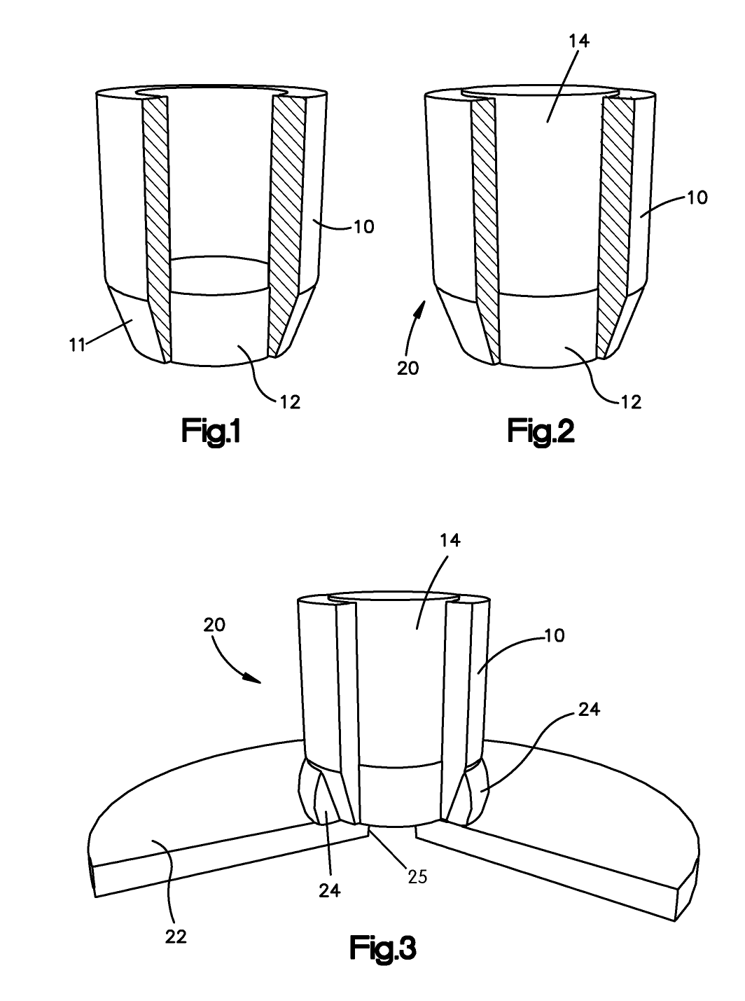

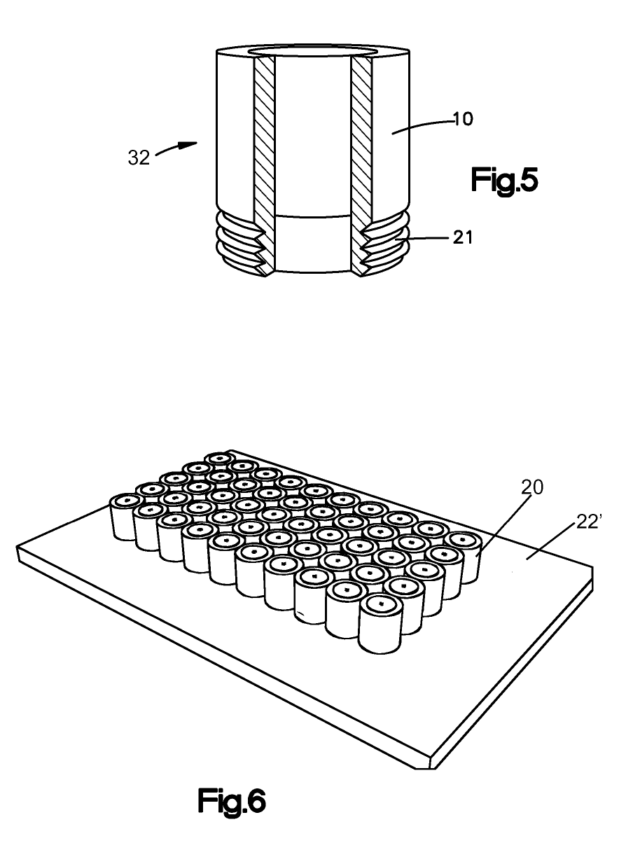

FIG. 1 shows a container 10 which can be a pipe or cylindrical section that typically may be 2″ diameter×2″ high. The wall thickness is typically ⅜″ and the thickness can vary along the length of the pipe to provide a bevel 11. The container may be other shapes such as square or hexagonal. The container material should be a hardenable alloy such AISI 4340, 4140 or Abrasion Resistant plate cut to dimension of the desired container, but not limited to such abrasions resistance. It could be mild steel. The container 10 is placed on a non-weldable grounded surface such as graphite or copper. If the container 10 is placed on a non-conducting surface such as ceramic, sufficient grounding of the container is required. A thin plug 12 having dimensions that will just fit the inside the dimensions of the container 10 placed as shown. The plug is typically, but not limited to mild steel. It will act as a starter material for a subsequent wear resistant deposit material 14 in FIG. 2 that will be arc welded into the container and filled to the top as shown. The combination of the container and wear resistant deposit material forms a finished product or consumable 20 that is then cooled properly to produce a sound deposit. The container 10 can be beveled or chamfered prior to or after any arc welding operation to allow easy post welding to an intended substrate. FIG. 3 shows the consumable 20 welded to the substrate 22 using proper filler metals such as mild and low alloy electrodes in a fillet weld 24. The finished product 20 could also be plug welded from the backside of a substrate plate 22 provided said plate contained complementary holes 25. A number of these consumable assemblies can be welded to a substrate to form a near continuous surface 22 (See FIG. 6). The container 10 will most likely wear first and could possibly act as a wear debris receptacle to slow the total wearing process.

The wear resistant material 14 of the present invention can comprise an arc welded metal based alloy consumable. In an embodiment of the invention the metal based alloy can comprise an iron based alloy, a nickel based alloy, a cobalt based alloy, or a mixture of any of the foregoing alloys. Because of cost-performance advantages, the wear resistant material generally comprises an iron based alloy. In another embodiment of the invention the metal based alloy produces a sound deposit resulting wear resistant material for filling the containers. The metal based alloy can comprise the said metal and one or more elements. The one or more elements of the metal based alloy can comprise chromium, molybdenum, titanium, tungsten, vanadium, niobium (formerly columbium), cobalt, boron, silicon, copper, manganese, nickel, carbon, iron, or combinations of any of the foregoing elements.

In a further embodiment of the invention the metal based alloy can comprise of hard alloys known as carbides, nitrides, borides or silicides hereafter referred to as Xides, or combinations of these. The Xide containing metal based alloy can comprise a chromium, a molybdenum, a titanium, a tungsten, a vanadium, a niobium, a boron, or combinations of any of the foregoing Xides. In still another embodiment of this invention the carbide containing metal based alloy can comprise a Xide iron based alloy. The Xide iron based alloy can comprise iron, manganese, silicon, chromium, carbon, columbium (now called niobium) and vanadium. Metal based alloys are available commercially or can be prepared by known procedures such as the procedure disclosed in international publication number WO 2005/078156 which is hereby incorporated by reference for its disclosure. Useful metal based alloys include commercially available iron based alloys such as for example Postle Industries Product Inlay 93 as disclosed herein below in Example 1. This product is a high carbon-low chromium multi phase alloy with multiple Xides formed by additions of Columbium (or niobium) and Vanadium. The Product Inlay 93 product has the following properties.

### EXAMPLE 1

Typical Chemical Analysis:

| | |
|---|---|
| Carbon | 4.10 |
| Chromium | 5.25 |
| Silicon | .50 |
| Manganese | .75 |
| Iron | Balance |
| Columbium | 4.50 |
| Vanadium | 4.30 |

Mechanical Properties

| | Yield | | | Hardness |
|---|---|---|---|---|
| Tensile psi | psi | % Elongation | Charpy V-Notch | Per ASTM E-18.0 |
| N/A | N/A | N/A | N/A | 55-60Rc |

The exemplary embodiment uses a commercially available product having this constituency. A range of values to adjust the physical characteristics of the wear resistant material is appropriate and is specified in the following listing.

### EXAMPLE 2

Chemical Ranges for Wear resistant material

| | |
|---|---|
| Carbon | 3.50-4.50 |
| Chromium | 4.0-6.0 |
| Silicon | .25-.75 |
| Manganese | .25-1.00 |
| Iron | Balance |
| Columbium | 3.50-5.50 |
| Vanadium | 3.50-4.50 |

Mechanical Properties

| | Yield | | | Hardness |
|---|---|---|---|---|
| Tensile psi | psi | % Elongation | Charpy V-Notch | Per ASTM E-18.0 |
| N/A | N/A | N/A | N/A | 55-60Rc |

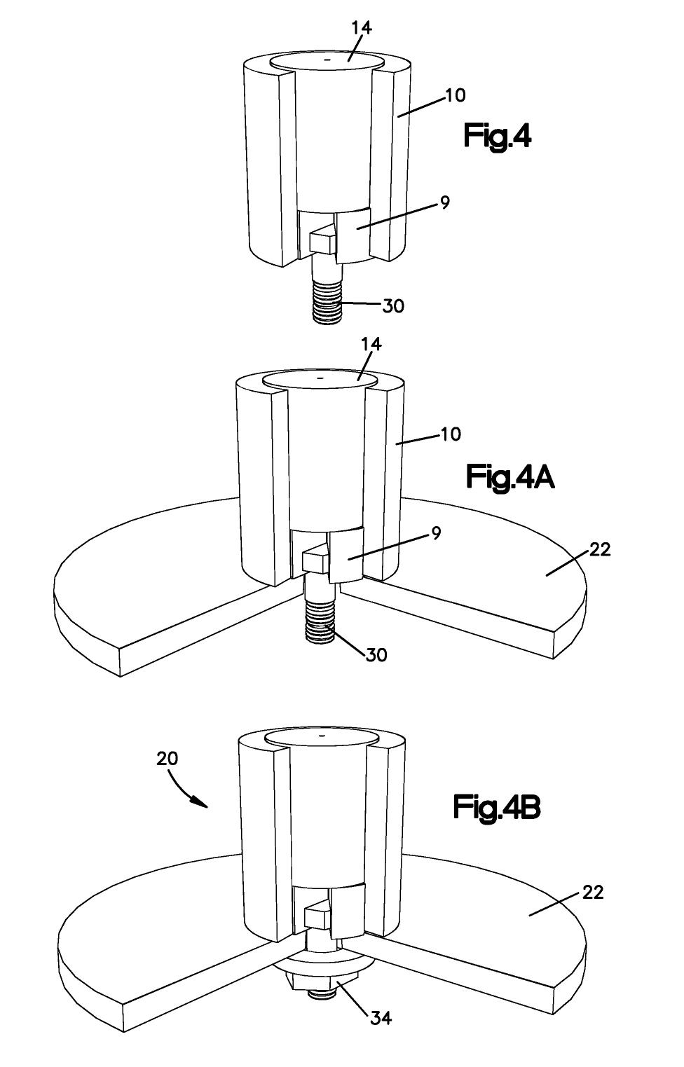

An alternative method for fabricating the consumable would be to place a bolt 30 in place of the thin plug 12 (See FIG. 4). This illustration shows a container 10 that has been filled with wear resistant material 14. The bottom has a bolt 30 that was inserted prior to welding. A mild steel electrode or wire could be used in the initial phase of producing a weld bead 9 just to secure the bolt to the container walls. The wear resistant material 14 is then later welded to a level of the top of the container. If the wear resistant depoist is ductile enough the mild steel could be eliminated. FIGS. 4A and 4B show the assembly 20 bolted onto a substrate 22 by tightening a nut 34 on a side of the base removed from the wear resistant deposit. A number of such assemblies could be bolted to a substrate 22′ to form a continuous surface FIG. 6. This would benefit applications where a small section wears away quickly. Bolted assemblies could be more easily replaced without having to change out the entire substrate.

The aforementioned method of producing wear resistant consumables allows thick deposits in excess of ½ inch to be successfully made because of the constraints of the container. Their size and portability makes them very versatile and easily applied in any and all positions. In the case of a base plate that is cut with predetermined container shapes, and filled with wear resistant material, the placement of the completed assembly is also versatile and easily accomplished in a manufacturing facility as well as in the field.

FIG. 5 shows a finished container 10 filled with wear resistant material to form an assembly 32, appropriately machined threads 21 at one end for the purpose of attachment to a substrate plate containing complimentary threaded hole. A number of assemblies 32 can be attached to a substrate plate forming an almost continuous wear resistant surface.

The choice of wear resistant and container material can be varied to suit the application. Sound wear resistant deposits are most desirable, but is not limited to that choice. Preheat and interpass temperatures between adjacent weld sites are monitored as overheating of the container material is a distinct possibility.

FIG. 6 shows an array of consumables 20 fillet welded, plug welded, bolted or threaded to a base plate 22. The actual diameter, thickness and placement of the consumables are all variables that can be altered to fit the application, for example, if more container material is needed the wall thickness can be increased or the spaces left by the consumable placement can be filled in with appropriate weld metal. If the wear media is large in size, such as rocks, the consumable placement may be further apart and conversely, closer together, if the wear media is fine, such as sand.

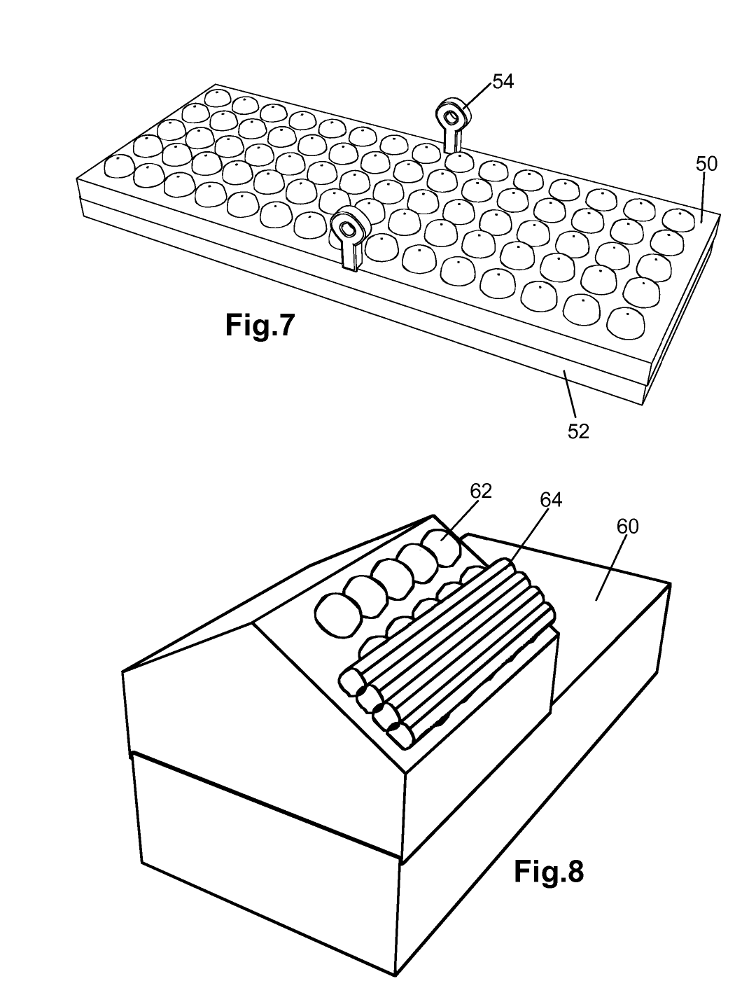

This is also trite of an Abrasion Resistant plate 50 as shown in FIG. 7 that has been cut with predetermined container designs, such as holes or hexagons sized to accept the containers. This plate is then plug and seam welded to a substrate plate 52. The containers are then filled to the top. Lifting lugs 54 are attached for transportation. Another alternative is to mix or stagger highly abrasive consumables for high wear areas with lesser abrasive consumables for low wear areas.

As previously mentioned the container is not restricted to cylindrical, square or hexagon shapes It could be a casting, forging or fabrication that provides containers therein. For example, the FIG. 8 embodiment shows a crushing hammer 60 fabricated from Ti or AR plate with holes drilled in it to accommodate the wear resistant deposit 62. In this case the fabrication is the container, but it could very well have been a forging or casting. A layer of hardfacing 64 has been applied to enhance the overall wear. Application of the hardfacing layer is performed as in currently known techniques.

Another application is in the area of industrial fan blades. These are often fabricated from Abrasion Resistant (AR) plate or Chromium Carbide overlay plate. The metallurgy of the Overlay Plate is far more abrasion resistant than the AR plate, but it also has another unique advantage. The Overlay Plate has characteristic weld beads along one axis. This is of course due to the welding process. However, if the beads run perpendicular to the flow of the media, wear life is enhanced over the beads that run parallel with the flow. The theory is that the perpendicular beads set up a turbulence, and thus keep the particulate off the plate. Despite this advantage overlay plates are limited to ⅛″ of overlay thickness because of size and weight considerations.

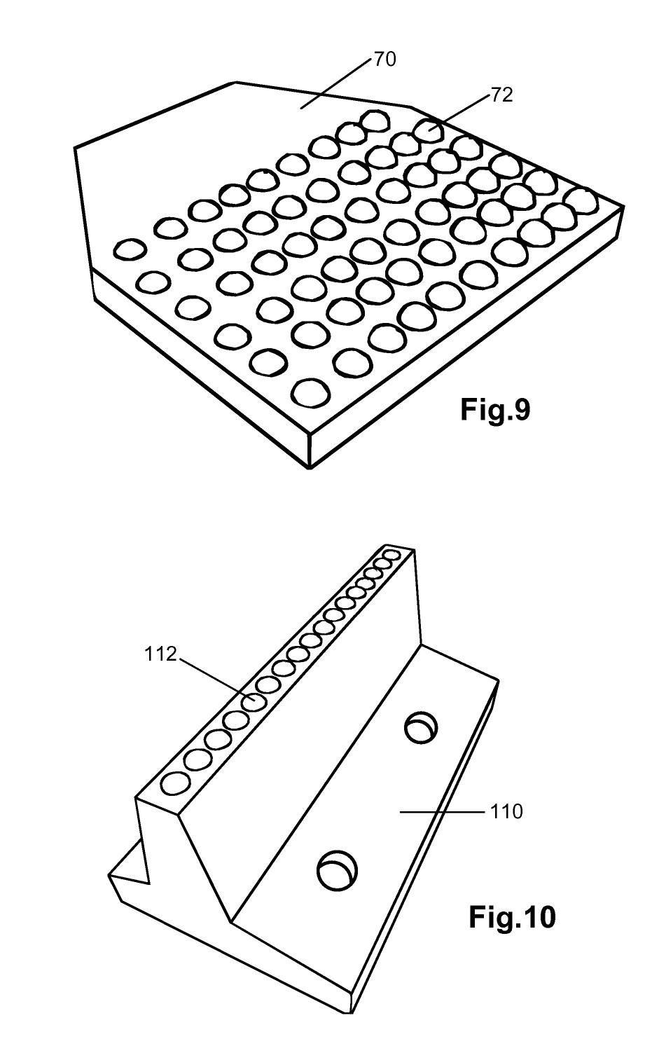

A fan blade 70 (FIG. 9) is fabricated using the disclosed process and would offer the same turbulence as the beads in a blade constructed using an overlay plate, but with added advantage having the container sites 72 which extend through the thickness of the fan blade plate, thereby extending the overall wear life. This plate is roughly ⅜″ thick. Also the wear resistant material welded into the holes or shapes could be altered according to the areas of maximum wear, which is usually in the center and front portion of the blade. This fan blade would have superior wear at a very competitive price. Containers of varied dimensions and shapes could be provided for specific wear areas in the blade to provide a more economic component.

FIG. 10 shows a dozer shoe grouser 110 having containers drilled and Filled with a wear resistant material 112. The actual hole size and configuration is dependent upon the flex and environment that the track operates. The grouser does flex during operation and the material between the containers will act as the flex point, keeping the container in tact for abrasion resistance. Hole or container depth can be altered to accommodate high wear areas. They can also be altered to extend wear life to better match maintenance cycles.

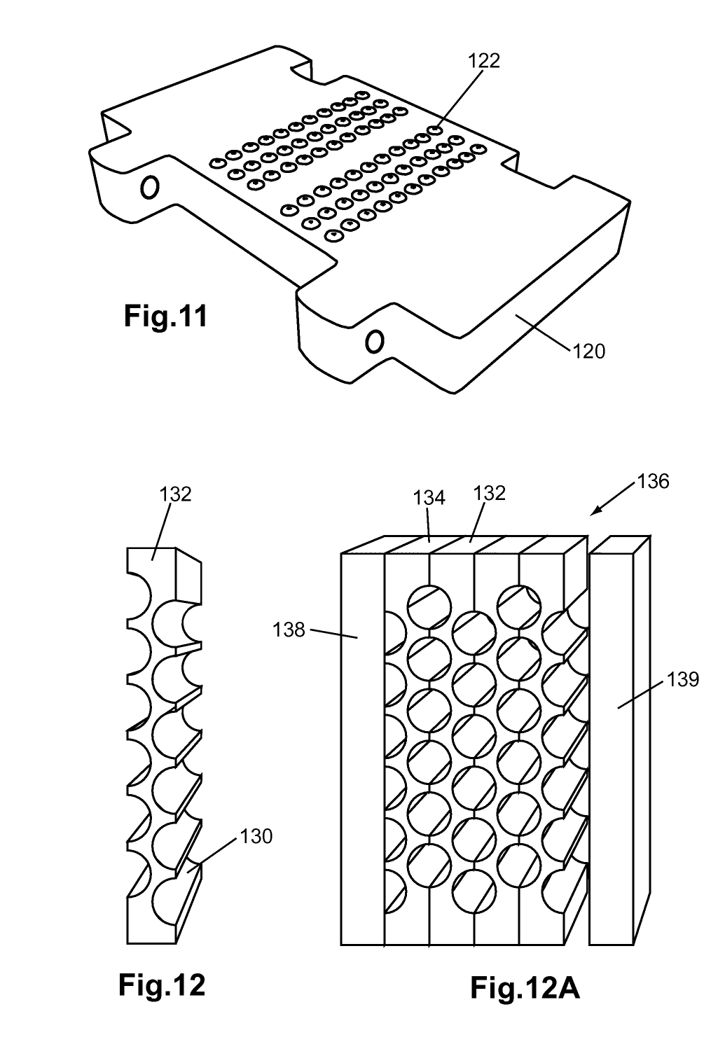

FIG. 11 shows a bulldozer track link pad 120. The highest wear area occurs where the bottom rollers roll over the link. Here containers can be drilled or cast into the base material of the link and filled with appropriate wear resistant material 122. The hole size and configuration may be dictated by the individual loads applied to the dozer track. Component life can be regulated by varying the depth of the containers. Small containers have an advantage over larger containers. Small containers will tend to spread the stress over more containers in addition to creating a smoother pad for the rollers.

In a further embodiment of this invention, container walls 130 (FIG. 12) are formed in an elongated form or component 132 which when mated with other forms or components 134 complete an assembly 136. The containers are then filled with a suitable wear resistant material. (not shown). The containers can be castings, forgings, flame cut, plasma cut or water jet components. These components when connected to form an assembly can be stacked vertically and horizontally to form a plate of varying thicknesses, lengths and widths. Side bars 138, 139 can be used to complete the container assembly where needed. With the appropriate wear resistant material selected the components will become a single entity or assembly through welding or container filling.

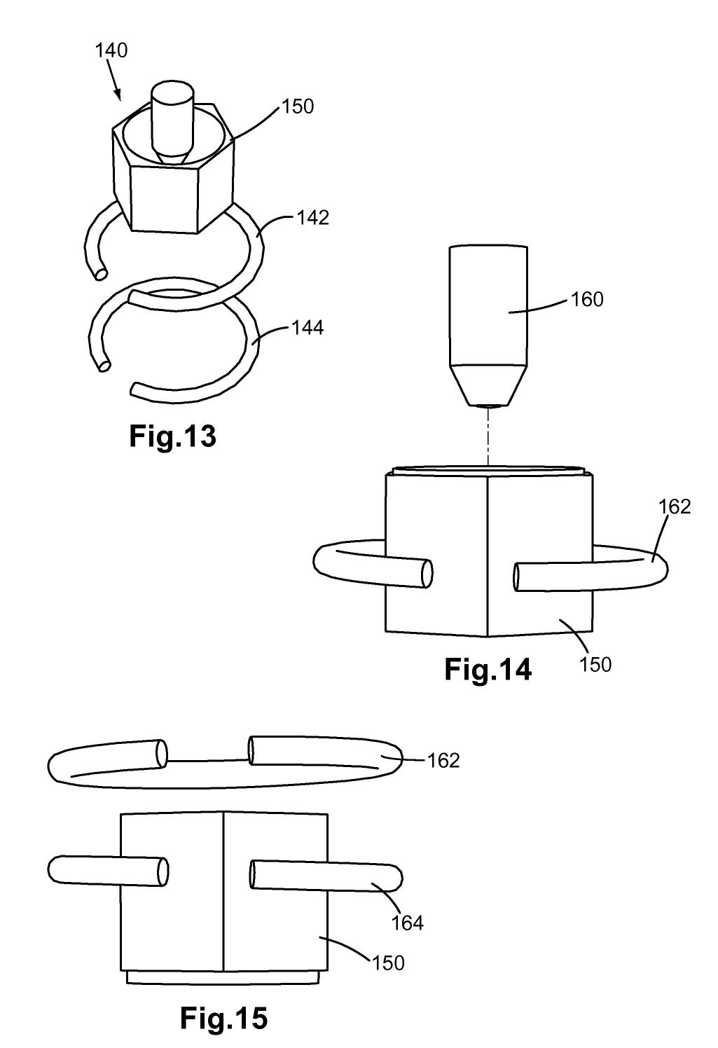

FIG. 13 shows a typical production assembly for the fabrication of portable container consumables, consisting of a welding station 140, heating station 142 and cooling station 144. The welding station is stationary, while a container 150 and weld metal move vertically downward through the heating and cooling stations and finally are ejected and the next assembly is moved into the welding station 140 and the process repeats.

A container 150 in FIG. 13 could be a hardenable alloy casting such as AISI 4340 or 4140, and a hexagonal outer shape and cylindrical inner shape. The hexagonal shape is one of the more efficient shapes to occupy a square or rectangle. The inner cylindrical shape is chosen because it is the most efficient shape for a weld puddle although other shapes could be used. Its depth may vary depending upon welding parameters and end application.

This assembly is presented to the weld torch 160 as shown in FIG. 14 and manipulated downward as the container is filled. Immediately after the container is filled and while it is still hot, it is heated to solution heat treatment temperatures for purposes of hardening the container 150 by means of an induction coil 162 having a proper frequency to just heat the container only as shown in FIG. 14 and not the wear resistant deposit inside the container. For example, an 8 KC inductor would penetrate deeply, while a 15 KC would be shallower. The frequency may be altered according to the container shape, wall thickness etc.

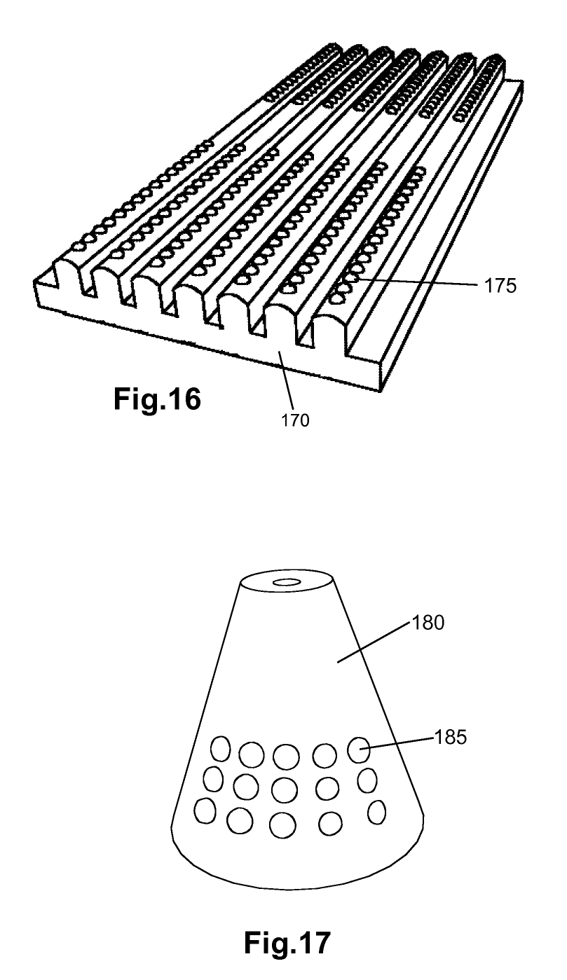

After being heated by the induction coil to the proper solution temperature it then passes down into the cooling station as shown in FIG. 15, where water jets from the water coil 164 and quench it for maximum hardness and abrasion resistance. If the sequence is done properly, only the container 150 will be affected by the heat treatment and quench. It may not be necessary to heat treat the wear resistant deposit.

FIG. 16 shows a jaw crusher liner plate 170, wherein containers are filled in strategic locations of high wear, 175. The liner can be rotated 180° for added wear resistance. Since most of the wear occurs at the bottom of the liner, deep containers are utilized there while shallow containers are utilized toward the center portions of the liner where wear is less severe.

FIG. 17 shows a cone or gyratory crusher mantle 80. The high wear area is generally closer to the bottom where containers 185 can be placed. These containers can be deeper than others located higher up on the cone to accommodate the high wear. Since these parts are generally a manganese steel, drilling may be difficult and gouging by carbon arc may be a preferred method of metal removal. The matching liner (not shown) can also be treated with containers and filled with abrasion resistant material. While the invention has been described with a degree of particularity it is the intent the invention include all modifications and alterations from the disclosed design falling within the spirit or scope of the appended claims

1. A method of wear protecting an object comprising:
a) providing a metal object having a desired shape for a task;
b) forming containers in said metal object in regions of said object that are subject to wear with use;
c) filling the containers with a wear resistant material more wear resistant than the metal object to prolong the useful life of said object.

2. The method of claim 1 wherein the step of forming is performed by drilling, machining, gouging, flame cutting, plasma cutting or any other suitable metal removal method into a surface of the metal object to a depth.

3. The method of claim 1 wherein the metal object is a fan blade.

4. The method of claim 1 wherein the metal object is a wear plate.

5. The method of claim 1 wherein the metal object is a bull dozer track pad.

6. The method of claim 1 wherein the metal object is a bull dozer grouser bar.

7. The method of claim 1 wherein the metal object is a crushing hammer.

8. The method of claim 1 wherein the metal object is a jaw crusher liner.

9. The method of claim 1 wherein the metal object is a cone crusher mantle.

10. The method of claim 1 wherein the metal object is a cone crusher liner.

11. The method of claim 1 wherein the metal object is a plate having wear resistant material as spaced sites across a surface of the plate and further comprising attaching the plate to a wear surface of a work implement.

12. The method of claim 1 wherein the wear resistant material comprises a metal based alloy wherein the metal based alloy comprises an iron based alloy, a nickel based alloy, a cobalt based alloy, or a mixture of any of the foregoing alloys.

13. The method of claim 1 wherein the metal based alloy used to fill containers comprises of one or any combination of carbides, nitrides, borides, or silicides formed from chromium, molybdenum, titanium, tungsten, vanadium, niobium, boron, or combinations of any of the foregoing alloy.

14. The method of claim 13 wherein the metal based allow produces a sound deposit.

15. A method of manufacturing a wear resistant product comprising:
providing a container and filing the container with a wear resistant material;
attaching the container to a substrate;
attaching additional containers having the wear resistant material to the substrate in abutting relation with already attached containers to form said wear resistant product.

16. An article of manufacture comprising:
an object body having a desired shape for a task; and
wear resistant sites formed from containers in the object body at locations of said object body that are subject to wear with use;
wherein the containers are filled with a wear resistant material that is more wear resistant than said object body to prolong the useful life of said object.

17. The article of claims 16 wherein the wear resistant material comprises a metal based alloy wherein the metal based alloy comprises an iron based alloy, a nickel based alloy, a cobalt based alloy, or a mixture of any of the foregoing alloys.

18. The article of claim 17 wherein the metal based alloy used to fill containers comprises of one or any combination of carbides, nitrides, borides, or silicides formed from chromium, molybdenum, titanium, tungsten, vanadium, niobium, boron, or combinations of any of the foregoing alloy.

19. The article of claim 18 wherein the metal based allow produces a sound deposit.

20. The article of claim 18 wherein the metal based alloy comprises an iron based ferroalloy comprising iron, carbon, manganese, silicon, chromium, niobium, and vanadium.

21. The article of claim 20 wherein the alloy produces a sound deposit.

22. The article of claim 20 wherein the hardness of the ferroalloy is in the range 55-60 Rc after it has solidified in the containers.

23. The article of claim 16 wherein the object is a fan blade.

24. The article of claim 16 and wherein the object is a wear plate.

25. The article of claim 16 wherein the object is a bull dozer track pad.

26. The article of claim 16 wherein the object is a bull dozer grouser bar.

27. The article of claim 16 wherein the object is a crushing hammer.

28. The article of claim 16 wherein the object is a stackable object creating containers to be filled with a wear resistant material.

29. The article of claim 16 wherein the object is a jaw crusher liner plate.

30. The article of claim 16 wherein the object is a cone crusher mantle.

31. The article of claim 16 wherein the object is a cone crusher liner.
